(19) United States
(12) Patent Application Publication
(10) Pub. No.: US 2015/0075145 A1
(43) Pub. Date: Mar. 19, 2015

(54) Diesel Dissipation Dryer Device

(71) Applicant: Bryan Alan Yonan, Mira Loma, CA (US)

(72) Inventor: Bryan Alan Yonan, Mira Loma, CA (US)

(21) Appl. No.: 14/487,962

(22) Filed: Sep. 16, 2014

Related U.S. Application Data
(60) Provisional application No. 61/879,883, filed on Sep. 19, 2013.

(51) Int. Cl. F01N 3/26; B23P 19/04

(52) U.S. Cl. CPC F01N 3/26; B23P 19/04
USPC 60/320; 29/428

(57) ABSTRACT

Improvements in a diesel emission control dryer is disclosed. The improvements provide a catalytic glow plug emission free exhaust system device that will product zero emission for clean air for future life. The diesel emission control dryer changes the current ways available to lower emissions. The process begins with the wet fuel exhaust exiting the turbocharger, spinning in the same direction. A plurality of glow plugs are used to heat the wet exhaust gas to dry the wet exhaust and burn all fuel and particulates. As the turbocharger glow plugs heat and dissipate all fuel and exhaust emissions that will exit the diesel emission control dryer at 0%.

### CROSS REFERENCE TO RELATED APPLICATION

This application claims the benefit of Provisional Application Ser. No. 61/879,883 filed Sep. 19, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in glow Plug Emissions Free Exhaust System device. More particularly, the present invention is a process begins with the wet fuel exhaust exiting the Turbo, spinning in the same direction. The spinning exhaust then enters a Dissipation Chamber where seven Glow Plugs heat and dissipate all fuel and exhaust emissions that will exit the device.

2. Description of Related Art Including Information Disclosed under 37 CFR 1.97 and 1.98

Most people associate diesel vehicles with as cars or trucks that expel large sums of black particulates into the air causing pollution. The particulates are generally caused by the combustion of the diesel fuel that is then expelled out of the exhaust system of the vehicle. Most filtering systems can become clogged and require maintenance at periotic intervals to prevent a reduction in performance.

Discovery and understanding will advance with this new and innovative technology by eliminating the risks of harmful chemicals created by current devices available, such as UREA. Urea is a known factor in Epstein Barr virus which is infecting and killing innocent people. The Clean Air Act demands that the millions of Diesel Truck drivers get their trucks retrofitted, which will broaden the participation immensely.

A number of patents and or publications have been made to address these issues. Exemplary examples of patents and or publication that try to address this/these problem(s) are identified and discussed below.

U.S. Pat. No. 4,902,309 issued Feb. 20, 1990 to George T. Hempenstall discloses an improved method for the ignition and combustion of particulates in diesel exhaust gases. The method includes a filter that filters the particles. While this filter can remove particulates, the filter must be replaced and cleaned for proper removal of the particles and operation of the engine.

U.S. Pat. No. 5,089,236 issued on Feb. 18, 1992 to James C. Clerc discloses a Variable Geometry Catalytic Converter. The Catalytic converter requires that the timing of the engine be adjusted to sufficiently heat the converter to burn the particulates. This patent further required the geometry of the converter to be adjusted based upon the engine load. While this patent can reduce the exhausted particulates the converter is less efficient and requires adjustment of the geometry while the engine is running.

U.S. Pat. No. 5,251,564 issued on Oct. 12, 1 993 to Julius J. Rim et al discloses a Combustion box exhaust filtration system and method. This patent also uses a filter that filters the particles. While this filter can remove particulates, the filter must be replaced and cleaned for proper removal of the particles and operation of the engine.

U.S. Pat. No. 8,529,652 issued on Sep. 10, 2013 for Roswitha Burkhardt discloses a Soot Particle filter. As the title of this patent indicates, the patent is a filter that removes the soot particles from the exhaust of the engine that enters the muffler or filter. The filter requires maintenance to keep the engine and exhaust system operating in optimal performance.

What is needed is a system that provides a constant dissipation dryer that operates at all engine speeds to remove obliterate all of the particulates from the exhaust that comes from the engine. The proposed diesel dissipation dryer provides a solution that can be added to nearly any existing diesel engine.

### BRIEF SUMMARY OF THE INVENTION

It is an object of the diesel dissipation dryer to provide as universal system for diesel engines, including commercial and off road equipment and will, in turn be used by a large variety of industries.

It is an object of the diesel dissipation dryer to produce zero emissions for clean air for future life.

It is another object of the diesel dissipation dryer to provide the world's first Catalytic Glow Plug Emissions free Exhaust System.

It is still another object of the diesel dissipation dryer to be cost effective, eliminates risk to us and the environment, and will produce results that will ultimately help to save the earth from pollution and benefit every human being.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an installed diesel dissipation dryer.

FIG. 2 shows a detailed view of the inside of the diesel dissipation dryer.

FIG. 3A-3D shows an installation method for installing a diesel dissipation dryer.

FIG. 4 shows an electrical connection of the diesel dissipation dryer into a vehicle.

FIG. 5A-5C shows different installation positions of a diesel dissipation dryer in the exhaust system of a vehicle.

### DETAILED DESCRIPTION OF THE INVENTION

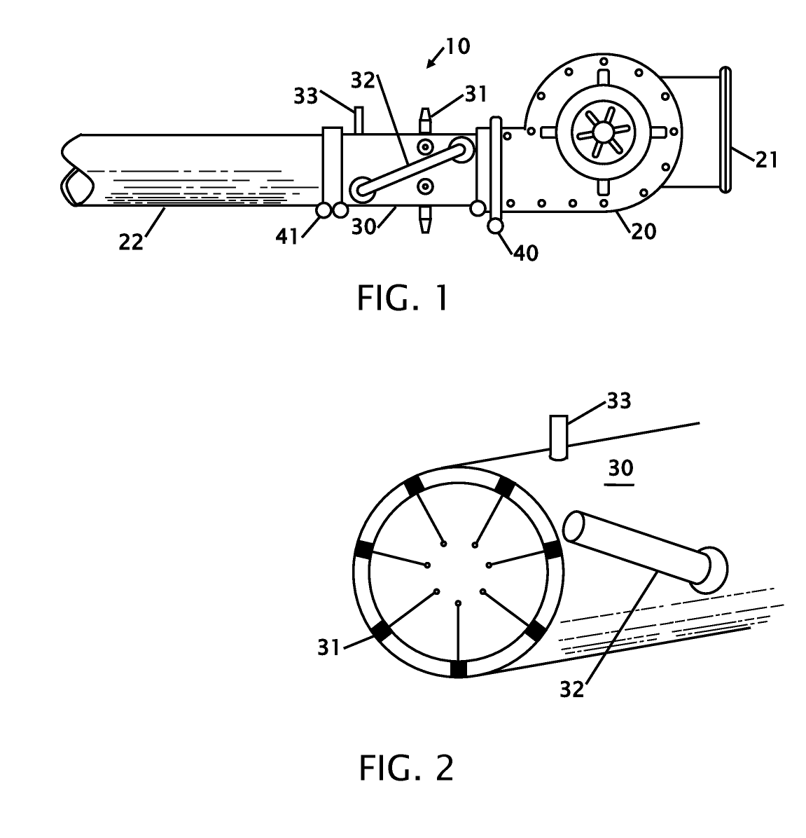

FIG. 1 shows an installed diesel dissipation dryer 10 and FIG. 2 shows a detailed view of the inside of the diesel dissipation dryer 10. The body 30 of the diesel dissipation dryer 10 is one tube grade 409 Stainless Steel. The diesel dissipation dryer 10 weighs about 7 pounds and is about 7 inches in length. The circumference is 5″ in diameter to be equivalent to the dimensions of an original exhaust pipe. While these dimensions and specifications are provided, they provide a general disclosure for prototypes that have been produced and tested.

Exhaust from the engine enters 21 into the turbine. The first stage is where the wet diesel exhaust leaves the turbo 20 and enters the diesel dissipation dryer. A clamp or other joining mechanism 40 joins the turbine or exhaust pipe to the diesel dissipation dryer 10.

The second stage is where the wet exhaust flows around the glow plugs 31. In the operational prototype, 7 glow plugs have been used, but a greater or lesser number of glow plugs 31 can be used based upon the flow rate, diameter of the exhaust pipe and the amount of particulates that are being removed. In the drying process in the chamber 30. The diesel dissipation dryer 10 has a sensor port 33 that monitors the diesel dissipation dryer 10.

In the third stage there is a dual, new generation return tubes 32 that adds cubic feet of air space, creating enough volume to aid in the free-flowing process, by returning any existing wet vapor in a continuous recycling process.

After the diesel dissipation dryer 10 the exhaust enters the remainder of the exhaust 22 where cleaner exhaust goes into a muffler or other treatment. A clamp or other joining mechanism 41 joins the diesel dissipation dryer 10 to the remainder of the exhaust system.

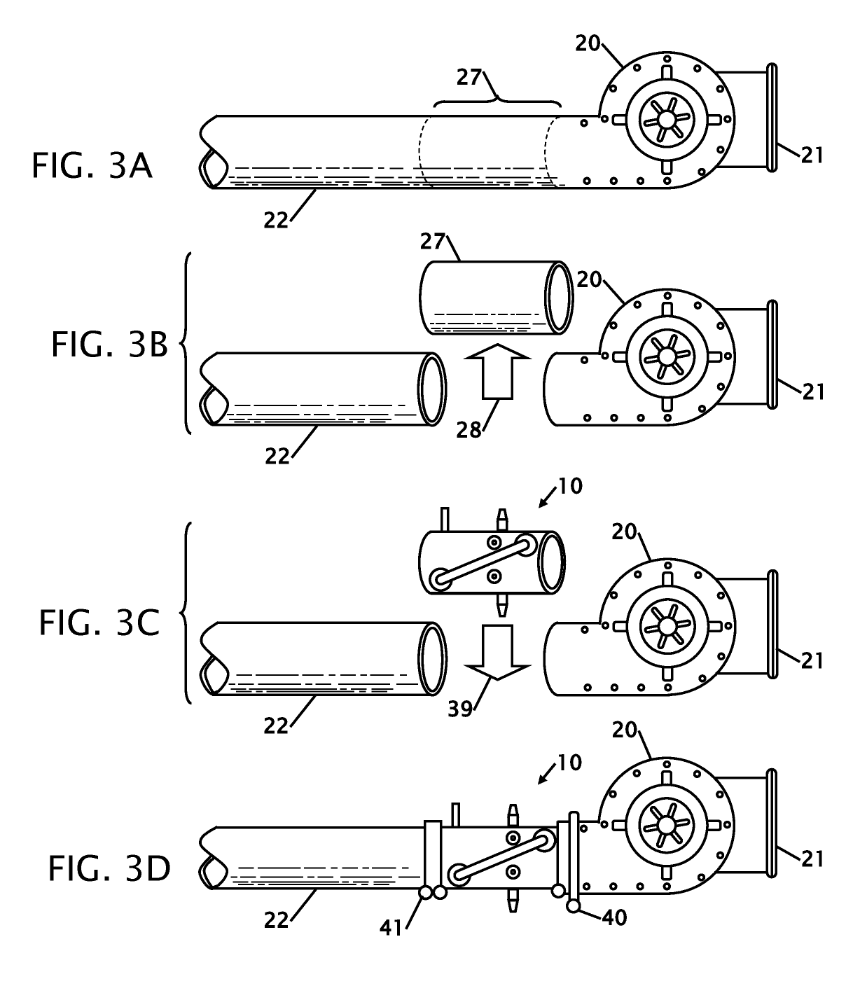

FIG. 3A-3D shows an installation method for installing a diesel dissipation dryer. To install the diesel dissipation dryer, an installer locates the turbocharger unit 20 located after the exhaust 21 or headers from the engine. The installer cuts through the exhaust after the turbocharger unit 20. The installer then measures 7 inches 27 from the previous cut and uses a power-cutting tool to make the second cut through the exhaust pipe 22 as shown in FIG. 3A.

In FIG. 3B the installer can then use a mallet by tapping the cut piece of the exhaust pipe loose and the removed section 27 of exhaust pipe 22 as shown in FIG. 3B and can set excess aside the removed section 27 or recycled removed section. The removed section can also be retained to reverse the process if required.

FIG. 3C shows placement 39 of the diesel dissipation dryer unit 10 into the area where the exhaust pipe 22 was previously removed. The diesel dissipation dryer unit 10 occupies the same position in the exhaust system where the removed piece of exhaust was previously located.

FIG. 3D shows the first shrink clamp 40 around the front end of the diesel dissipation dryer unit 10 and the existing exhaust pipe coming from the turbocharger 20. The installer fits the other shrink clamp 41 around the rear of the diesel dissipation dryer unit 10 and the existing exhaust pipe coming from the stack. Using a 9/16 wrench or other appropriate tool, the diesel dissipation dryer 10 is securely tighten onto the exhaust pipe with the shrink clamps 40 and 41.

The Stover nuts are unthreaded from the bottom of the exhaust band clamps and are separated into two pieces. The U-bolt piece of the clamps are placed around the body of the diesel dissipation dryer 10 (top) and is then connected to the saddle piece of the clamp from the underside of the body of the diesel dissipation dryer unit 10.

The threaded post is inserted through the U-bolt and into the existing OEM steel bracket located under the exhaust pipe under the cab of the vehicle. (original manufacturer exhaust bracket mount that comes standard in all diesel trucks) Thread the Stover Nuts to the U-bolt post underneath the OEM bracket, using a torque wrench to 23 lbs/in or to whatever the optimal torque for the nuts.

The diesel dissipation dryer 10 uses a glow plug control method for improving is disclosed that the method is used to reduce from diesel engine exhaust waste gas. Preferably, the catalyst for diesel engine to reduce the reduction of the discharge. For the compression ignition engine, the most commonly used catalyst is a diesel oxidation catalyst. The excessive oxygen using much in the exhaust stream. CO (carbon monoxide oxidation CO2 carbon dioxide), and fire-damp He is oxidized H2O (water and CO2. These switches are generally efficiency, and 90% help reduce visible particles (soot), however, as a result of the chemical reaction by the simplest path occurrence so that they cannot reduce NOx, in the exhaust stream exists O2 reaction. In order to reduce in compression ignition engine NOx, changes the exhaust gas composition.

Two types of main techniques:

The silicon control rectifier (SCR) and captures or NOx, NOx absorption. Adding catalyst important development performance by reducing the combustion (tight off) temperature of the catalyst, and during the minimum cold start emissions. During a cold start, the temperature of the catalyst is low, and switch is not activated. Therefore, not the ignition temperature of the catalyst, the conversion of the exhaust gas component at the temperature cannot achieve 50%. Hydrocarbon and CO can therefore not transform to, during engine start first several minutes, to process during periods in total discharge with the reason of significant contribution. The special technology has been developed during the minimum cold start emissions.

The fast combustion technology has an exhaust system design passive system for changing, or additional energy depending on the active system for controlled source, by increasing the exhaust gas temperature during a cold start. According to the present application, a method for controlling a glow plug method of the power supply is disclosed to reduce catalyst following engine exhaust emission. If at least one of the two groups of input values held in the input parameter space characteristic region is at least a predetermined activation time, then a glow plug is activated, or powered. If at least one of the two groups of input values maintained outside the input parameter space second characteristic region is at least a predetermined time and then deactivating a glow plug 31 by again deactivated, or cut off to a power supply of a glow plug 31.

The deactivation time can be set to zero. The first and one or more adjacent regions of the second characteristic region includes input parameter space. The Input parameter space by the input parameters, and restricts with input parameters as a plurality of sizes. The input value is a value of the input parameter through, and output value of by the sensor given, or by means of the calculated value of the sensor output value. The first and second characteristic region can be formed by limit for each input value specified range, the range is limited by the minimum and maximum threshold value in this case, the characteristic region by a single adjacent region of the n dimensional cube (n-dimensional cube) form is assigned. In particular, the range of the input value can be two input parameters. In this case, through the characteristic region square form. In a particular example an input parameter (combined intake).

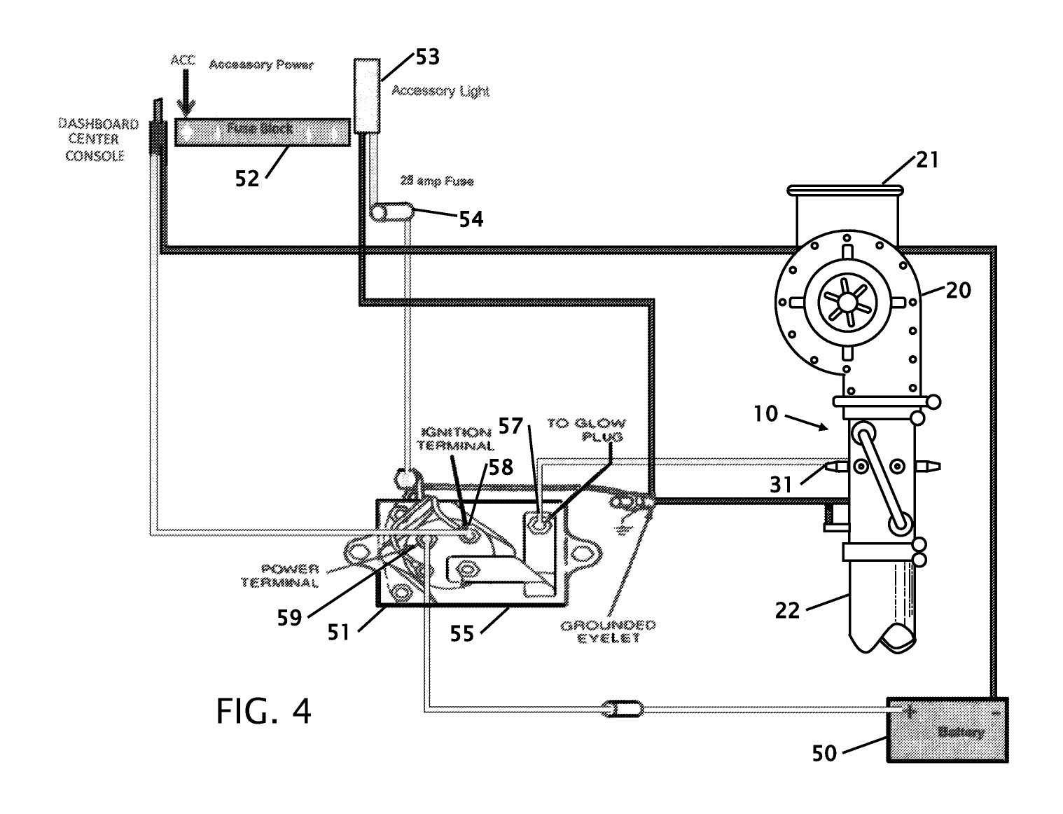

FIG. 4 shows an electrical connection of the diesel dissipation dryer into a vehicle.

The glow plugs 31 are preferably 6 mm in probe diameter, IIV 120 W, SMM terminal connector with a sheathed coil. The clamps are stainless steel shrink clamps that are used to fasten the diesel dissipation dryer to the exhaust tubes. The wiring harness is preferably constructed from 8 gauge with glow plug fasteners. The voltage regulator fuse regulates the voltage and reduces power from the battery 50 positive fixed 14 voltage regulator. The output current to greater than 2 amps the system draws about 50 watts under operation. The connection from the vehicle is through the accessory light 53 from the fuse block 52 then through a 25 amp fuse to the ignition terminal 58. The accessory light connects the wire harness so the diesel dissipation dryer 10 is energized when the engine is on or off.

The stainless steel unit is preferably constructed from 409 stainless steel and is 1/16 inch thick and having an outside diameter of 5 inches, an inside diameter of 4 inches and a length of 7 inches and weighs about 7 pounds. While these dimensions have been given, they are a preferred embodiment for a particular exhaust system. Other diameters and specifications are contemplated that will fit other vehicles to match the vehicle exhaust dimensions. The connecting nuts are stainless steel Stover nuts. The glow plug power control module 50 is essentially a 14 amp regulator that monitors the glow plugs 31 when the accessory is powered. The glow plug wiring harness includes wire connectors for the glow plug relay. The glow plug control module 55, wire harness for the unit and all of the mounting and basic hardware.

Wiring the PCM Mount the Glow Plug Controller 55 to the passenger side inner firewall. Then connect the red wire (8 gauge) connecter from the power terminal post 59 to the glow plug post 57 on the Relay.

Next connect the red wire (8 gauge) connector from the glow plug post 57 on the PCM, to the wire harness glow plug 57 connector from the ZE7P unit.

The black wire (8 gauge) connecter goes from the ground post on the PCM, to the ground post located on the rear end of the ZE7P unit the ground.

The sleeved wires are route from the PCM to the connector of the wire harness from the unit. The sleeved wires are inserted from the relay, through the rubber grommet and route them along the cab to the 12V battery 50. The battery 50 is the reconnect and the connections are tested.

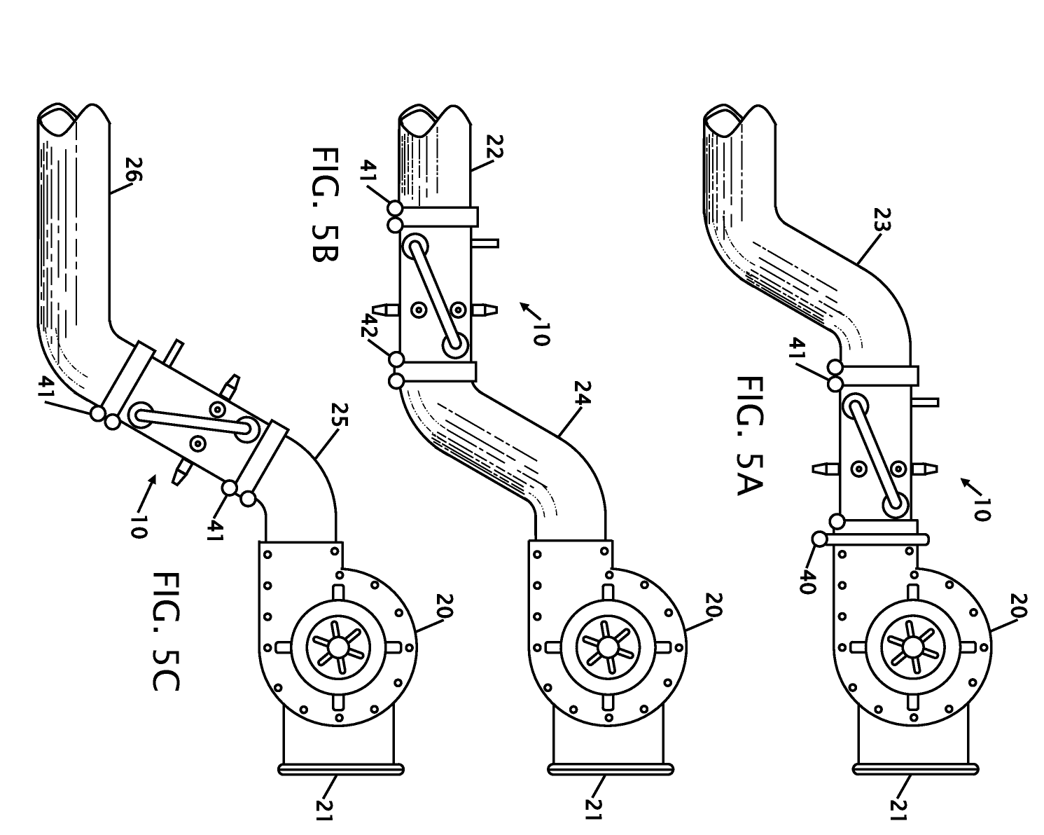

FIG. 5A-5C shows different installation positions of a diesel dissipation dryer in the exhaust system of a vehicle. The diesel dissipation dryer 10 is designed to be installed in-line into the existing exhaust system between the muffler and the turbocharger 20. Installation is essentially the same and applies to all engine models listed on Diesel Green Emissions new engine families list. Diesel engines for on-road applications with engine horse power ranging from 200-800 hp; highway heavy-duty, 4 cycle engines with model-years 1993-2007. Engine-makes: Caterpillar, Cummins, Detroit Diesel Corporation, Daimler-Chrysler, Hino, International, Isuzu, Mack, Mercedes and Volvo. Depending upon the installation the diesel dissipation dryer 10 can be installed directly after the turbocharger 20 or can be installed after one or more elbows 25 and run segments 24. Depending upon the installation one or multiple pipe clamps 40, 41 and 42 are required.

Thus, specific embodiments of a diesel green emissions control have been disclosed. It should be apparent, however, to those skilled in the art that many more modifications besides those described are possible without departing from the inventive concepts herein. The inventive subject matter, therefore, is not to be restricted except in the spirit of the appended claims.

1. A diesel green diesel dissipation dryer emissions control comprising:
an elongated cylindrical tubular body;
said elongated cylindrical tubular body having a receiving end for receiving wet vapors from exhaust of an engine;
said elongated cylindrical tubular body further having a plurality of glow plugs extending from an outside of said elongated cylindrical tubular body to an inside of said elongated cylindrical tubular body;
at least one return tube that is connected said elongated cylindrical tubular body at a location in front and behind said plurality of glow plugs, and
at least a sensor that monitors dried exhaust that has been dried by said plurality of glow plugs.

2. The diesel green emissions control dryer according to claim 1 wherein said engine is a diesel engine.

3. The diesel green emissions control dryer according to claim 2 wherein said dryer is located after a turbocharger.

4. The diesel green emissions control dryer according to claim 1 wherein said plurality of glow plugs is seven glow plugs placed equal distance around said cylindrical tubular body.

5. The diesel green emissions control dryer according to claim 1 wherein said dryer operates on engines selected from the group consisting of Caterpillar, Cummins, Detroit Diesel Corporation, Daimler-Chrysler, Hino, International, Isuzu, Mack, Mercedes and Volvo.

6. The diesel green emissions control dryer according to claim 1 includes at least two return tubes.

7. The diesel green emissions control dryer according to claim 1 that is sized to match an exhaust system connected to said engine.

8. The diesel green emissions control dryer according to claim 7 further includes clamps to secure said dryer to a pre-existing exhaust system.

9. The diesel green emissions control dryer according to claim 8 wherein said dryer is configured to retrofit into a said pre-existing exhaust system.

10. The diesel green emissions control dryer according to claim 1 further includes a control system that regulates power to said glow plugs.

11. A method for installing a diesel green emissions control dryer comprising:
identifying an installation location after a turbocharger in an exhaust line of a vehicle;
removing a section of exhaust pipe that is essentially equivalent to the length of a emissions control dryer;
installing said emissions control dryer where said section of exhaust line has been removed;
securing said emissions control dryer with clamps or the like to seal said emissions control dryer onto said exhaust line, and
electrically connecting said emissions control dryer to said vehicle's electrical system whereby glow plugs of said emissions control dryer are powered and controlled by a control system when an engine within said vehicle is operating.

12. The method for installing a diesel green emissions control dryer to claim 11 wherein said controller is powered by a pre-existing power source of said vehicle.

13. The method for installing a diesel green emissions control to claim 11 wherein said dryer operates on engines selected from the group consisting of Caterpillar, Cummins, Detroit Diesel Corporation, Daimler-Chrysler, Hino, International, Isuzu, Mack, Mercedes and Volvo.

14. The method for installing a diesel green emissions control dryer to claim 11 wherein said dryer is powered by an accessory connection to said vehicle.

15. The method for installing a diesel green emissions control dryer to claim 11 wherein said control system is connected to a firewall of said vehicle.

16. The method for installing a diesel green emissions control dryer to claim 11 wherein installation further includes electrical connection a plurality of glow plugs on said dryer.

17. The method for installing a diesel green emissions control dryer to claim 11 wherein said dryer is selected to be essentially a same diameter as said exhaust line.

18. The method for installing a diesel green emissions control dryer to claim 11 further includes connection of a sensor to said control system.

19. The method for installing a diesel green emissions control dryer to claim 11 wherein said vehicle has a 4-cycle engine.

20. The method for installing a diesel green emissions control dryer to claim 11 wherein said method further include connecting said control system a battery within said vehicle.
